(19) United States
(12) Patent Application Publication
(10) Pub. No.: US 2003/0069847 A1
(43) Pub. Date: Apr. 10, 2003

(54) Self-service terminal

(75) Inventor: Michael Dillon, Malahide (IE)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/252,900

(22) Filed: Sep. 23, 2002

(30) Foreign Application Priority Data
Oct. 10, 2001 (GB) 0124273.4

(51) Int. Cl. G06F 17/60

(52) U.S. Cl. 705/43

(57) ABSTRACT

A self-service terminal (10) having a user interface (14) for interacting with a user (12) is described. The terminal (10) may be an ATM and includes a programmable personality controller (74), and control means (72) such as an ATM application program. The personality controller (72) has a plurality of different personality settings. The control means (72) is responsive to the programmable personality controller (74) and adapts the ATM's interaction with the user in response to the setting of the personality controller (74). A method of interacting with a user at a self-service terminal is also described.

### BACKGROUND OF THE INVENTION

The present invention relates to improvements in or relating to a self-service terminal (SST), such as an automated teller machine (ATM).

ATMs are public access terminals that provide users with a convenient source of cash and other financial transactions and services. With the advent of surcharging (that is, levying a charge on each cash withdrawal transaction at an ATM for the use of the ATM), ATMs are now installed in retail outlets to provide a revenue stream for the owners of the retail outlets. Typically, a retailer receives a percentage of each surcharge levied on a transaction.

For a retailer to profit from an ATM, the ATM must perform, on average, a certain number of transactions each day. Once this number has been exceeded, the income from each surcharge represents a profit for the retailer. To maximize the profitability of such an ATM, it is desirable to stimulate as many transactions as possible.

One problem faced by a retailer is that all ATMs offer the most common transaction—cash dispensing. This means that it is difficult for a retailer to differentiate an ATM located in the retailer's outlet from an ATM located in another retail outlet. If a retailer cannot differentiate his ATM from other ATMs, then it is difficult to attract users to the ATM other than those users for whom the ATM's location is convenient. Without being able to attract more users, it is difficult for a retailer to increase the revenue stream from an ATM.

### SUMMARY OF THE INVENTION

It is among the objects of an embodiment of the present invention to obviate or mitigate the above disadvantage, or other disadvantages associated with prior art self-service terminals.

According to a first aspect of the present invention there is provided a self-service terminal having a user interface for interacting with a user, characterized in that the terminal includes a programmable personality controller having a plurality of personality settings, and control means responsive to the programmable personality controller for adapting the terminal's interaction with a user in response to the setting of the personality controller.

The personality controller is preferably a software module having a programming interface for allowing a retailer to select one of the plurality of personality settings.

The control means may include a plurality of different pre-recorded sentences, each sentence being spoken by a plurality of different types of voices, so that each personality setting has an appropriate statement and/or instruction for each stage in a transaction. For example, the control means may store the sentences: “Please insert your card”, “Please remove your cash”, and “Please remove your card”. One stored version of the sentence “Please insert your card” may be spoken by a cheerful female voice, another stored version of this sentence may be spoken by a miserly male voice.

The control means may include a random personality selection so that the terminal may emulate a different personality setting than the setting that was programmed by the retailer. This introduces a random element to a transaction to avoid a user being able to predict the terminal's interaction.

The personality settings may include one or more from the following: happy, unhappy, distant, tired, giggly, solemn, cheerful, and miserly.

The terminal may be an ATM. Alternatively, the terminal may be a non-cash kiosk, a point of sale terminal, or such like.

The personality controller may be operable to store a timetable of personality settings, so that the settings change automatically according to the time of day and/or the day of the week. This enables the controller to have a personality setting scheduled for each time of day and for each day of the week. For example, on Monday forenoons the setting may be happy; on Wednesday afternoons the setting may be miserly; on Friday evenings the setting may be jolly.

The ATM may use the same screens regardless of the personality type being emulated, and may emulate a personality type by playing different messages through a loudspeaker, depending on the personality type being emulated. In such an embodiment, the text presented on any particular ATM screen is not changed by the personality type being emulated. Alternatively, the ATM may populate a screen with text that is specific to a personality type.

The term “screen” is used herein to denote the graphics, text, controls (such as menu options), and such like, that are displayed on an SST display; the term “screen” as used herein does not refer to the hardware (for example, the LCD, CRT, or touchscreen) that displays the graphics, text, controls, and such like. Typically, when a transaction is being entered at an SST, a series of screens are presented in succession on the SST display, the next screen displayed being dependent on a user entry relating to the current screen. For example, a first screen may request a user to insert a card, a second screen may invite the user to enter his/her personal identification number (PIN), a third screen may invite the user to select a transaction, and so on.

By virtue of this aspect of the invention, an ATM is provided that interacts with a user in a more human way, thereby attracting users to the ATM and enabling a retailer to differentiate an ATM located within his/her retail outlet from an ATM located elsewhere.

According to a second aspect of the present invention there is provided a method of interacting with a user at a self-service terminal, the method comprising the steps of: receiving a personality type to be emulated; and providing user instructions in a manner consistent with the personality type being emulated.

### BRIEF DESCRIPTION OF THE DRAWINGS

These and other aspects of the present invention will be apparent from the following specific description, given by way of example, with reference to the accompanying drawings, in which:

FIG. 1 is a block diagram of a self-service terminal according to one embodiment of the present invention;

FIG. 2 is a block diagram of a part (the controller) of the terminal of FIG. 1;

FIGS. 3A to 3F illustrate a sequence of screens displayed on the terminal of FIG. 1 while a retailer is programming a personality setting;

FIGS. 4A to 4F illustrate a sequence of screens presented to a user of the terminal of FIG. 1 on one day of the week; and

FIGS. 5A to 5F illustrate a sequence of screens presented to a user of the terminal of FIG. 1 on another day of the week.

### DETAILED DESCRIPTION

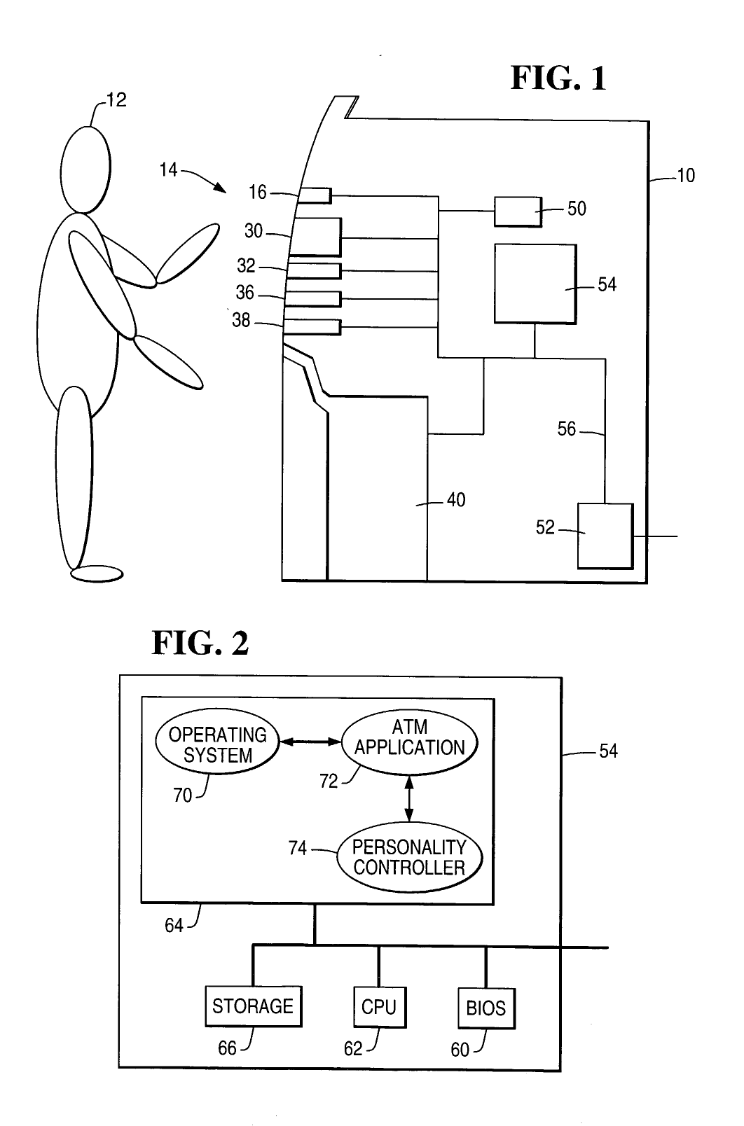

Reference is now made to FIG. 1, which illustrates an SST 10 in the form of an ATM being operated by a user 12.

The ATM 10 includes a user interface 14 for outputting information to a user and for allowing a user to input information.

The user interface 14 is a molded fascia incorporating: a loudspeaker 16, a display module 30, an encrypting keypad module 32, and a plurality of slots aligned with modules located behind the fascia. The slots include a card entry/exit slot (not shown) that aligns with a magnetic card reader/writer (MCRW) module 36, a printer slot (not shown) that aligns with a printer module 38, and a cash dispense slot (not shown) that aligns with a cash dispense module 40.

The ATM 10 also includes an internal journal printer module 50 for creating a record of all transactions executed by the ATM 10, a network connection module 52 (in the form of a dial-up modem) for communicating with a remote transaction host (not shown) for authorizing transactions, and an ATM controller module 54 for controlling the operation of the various modules (18 to 52). All of the modules (18 to 54) within the ATM 10 are interconnected by an internal bus 56 for securely conveying data.

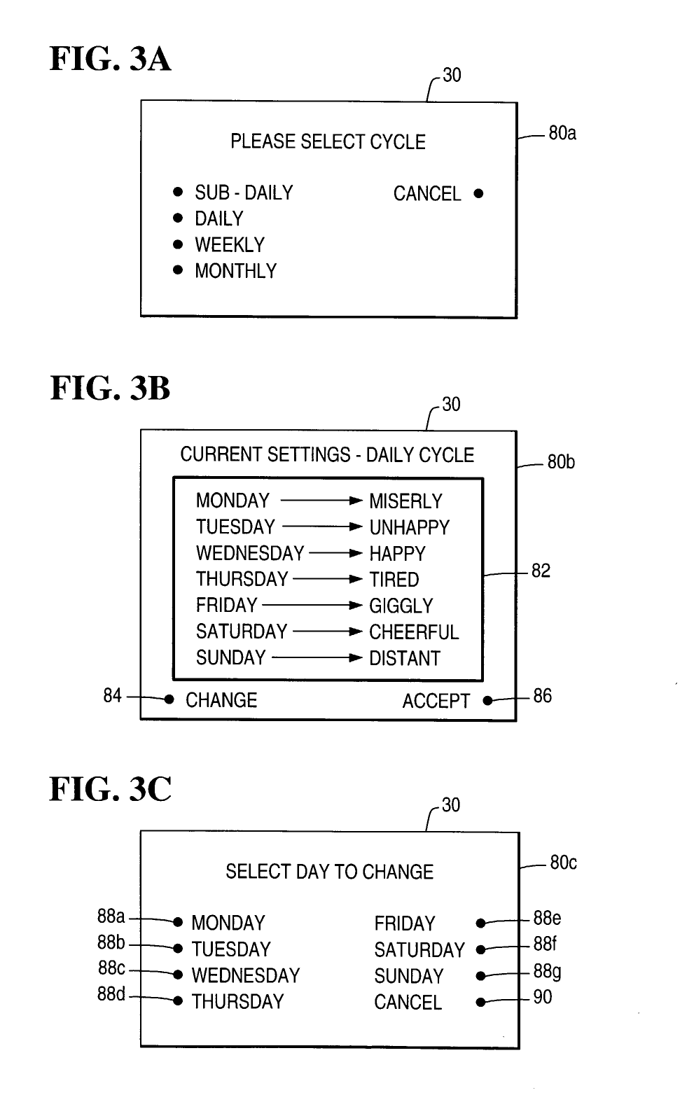

The ATM controller module 54 is shown in more detail in FIG. 2. The controller 54 comprises a BIOS 60 stored in non-volatile memory, a microprocessor 62, associated main memory 64, and storage space 66 in the form of a magnetic disk drive.

In use, the ATM 10 loads an operating system kernel 70, control means 72 (in the form of an ATM application program), and a personality controller program 74 into the main memory 64.

The ATM application program 72 is used to control the operation of the ATM 10. In particular, the ATM application program 72: provides the sequence of screens used in each transaction (referred to as the application flow); plays messages via the loudspeaker 16; monitors the condition of each module within the ATM (state of health monitoring); and interfaces with the personality controller program 74.

The personality controller program 74 allows an operator to select a personality type from a list of personality types, and informs the ATM application program 72 of the personality type selected by conveying a code indicating the personality type. In this embodiment, the personality types are: happy, unhappy, distant, tired, giggly, solemn, cheerful, and miserly.

The ATM application program 72 receives this code and accesses a stored look-up table (not shown) having an index entry for each code. Each code in the look-up table (LUT) has a unique transaction flow associated with it. The LUT and all of the different transaction flows (for the different personality types) are stored in the magnetic disk drive 66.

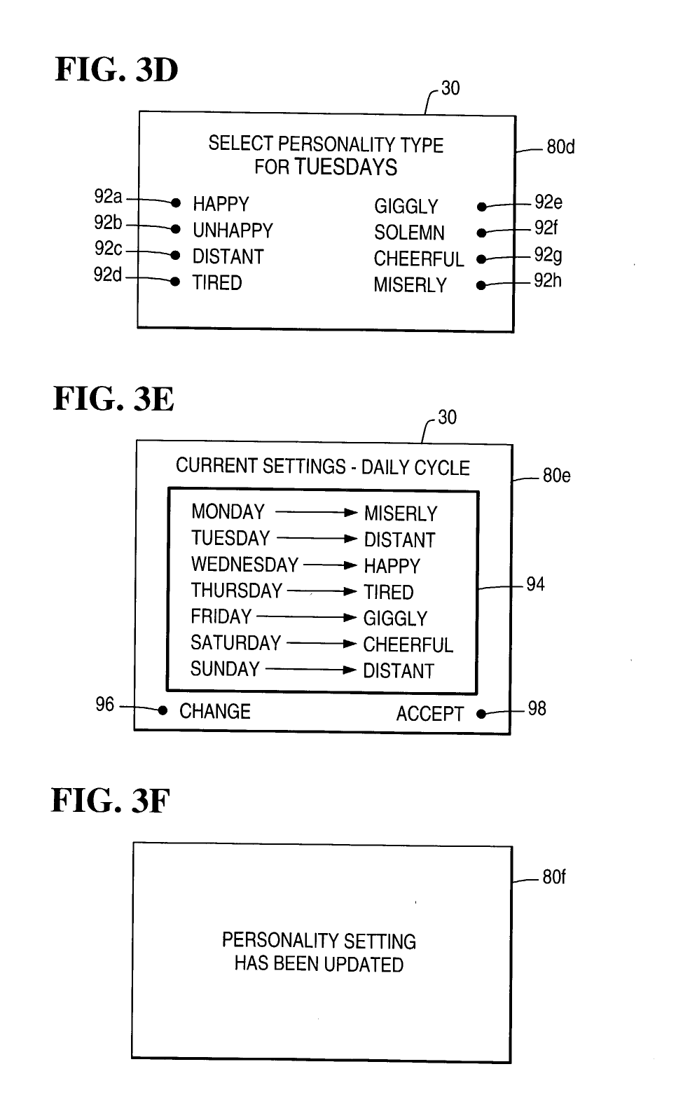

To program the personality types used by the ATM 10, a retailer uses the personality controller 74 (which is accessed by entering a password while the ATM 10 is in a supervisor mode). The personality controller 74 provides the retailer with different options, as shown in FIG. 3A.

The personality controller 74 presents the retailer with a screen 80a showing different cycles that can be chosen: sub-daily (which may be divided into hours or groups of hours), daily, weekly, and monthly. In this example, the retailer selects the daily cycle.

The personality controller 74 then presents the retailer with a current settings screen 80b having a table 82 showing the current settings for a week, and providing a selectable option 84 for changing the current settings and a selectable option 86 for accepting the current settings. In this example, the retailer opts to change the current settings.

The personality controller 74 then presents the retailer with a day selection screen 80c listing the days in a week as selectable options 88a to 88g, and a cancel option 90. In this example, the retailer desires to change the ATM's personality on Tuesdays from “unhappy” to “distant”. To achieve this, the retailer selects the Tuesday option 88b.

The personality controller 74 then presents the retailer with a personality selection screen 80d for Tuesdays. This screen 80d lists the available personality types as selectable options 92a to 92h. The retailer selects the “distant” option 92c.

The personality controller 74 then presents the retailer with an updated current settings screen 80e having an updated table 94 showing the current settings for a week, and providing a selectable option 96 for changing the current settings and selectable option 98 for accepting the current settings. As the retailer has now changed the settings, the retailer opts to accept the current settings.

The personality controller 74 then presents the retailer with a screen 80f indicating that the personality settings have been updated.

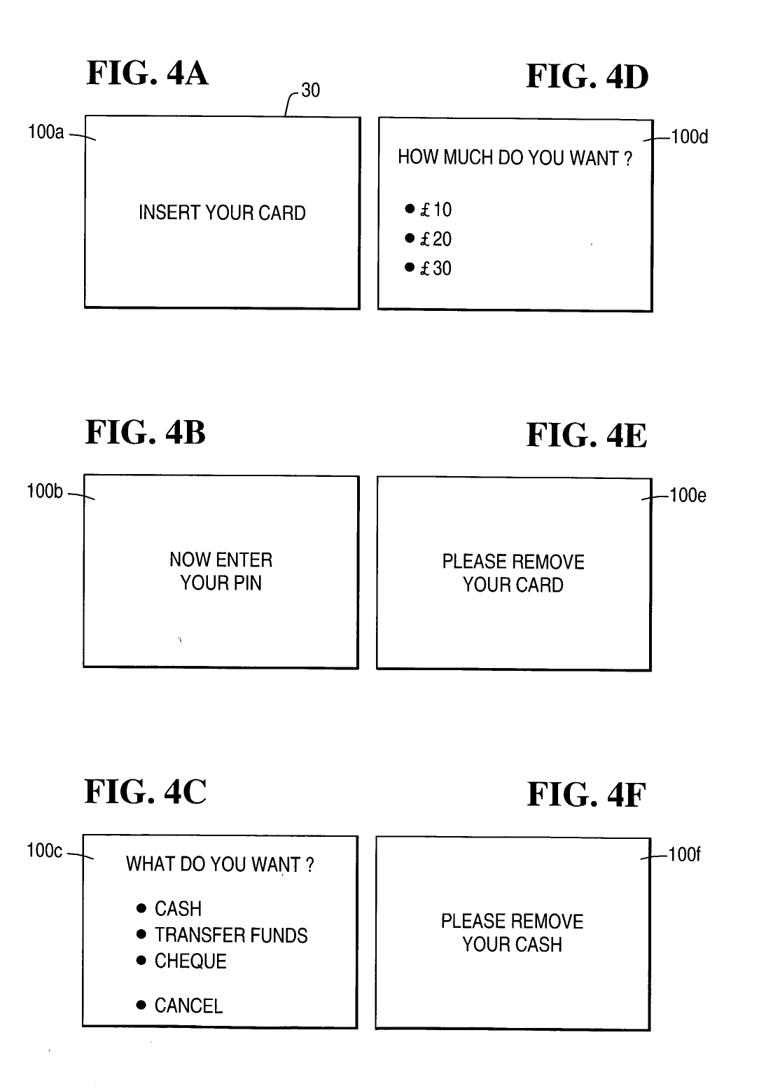

An example of a typical transaction at the ATM 10 will now be described with reference to FIGS. 4A to 4F, which illustrate the sequence of screens presented to the user 12 when the ATM is emulating one personality type. In this example, which occurs on a Monday, the ATM emulates the personality of a miserly individual.

When the user 12 approaches the ATM 10 he is presented with a not particularly welcoming attract screen 100a (FIG. 4A) on display 30 inviting a user to insert a card. While the attract screen 100a is being displayed, the ATM application program 72 plays a prerecorded sentence, through the loudspeaker 16, in which the words “Everyone always wants money” are spoken in a miserly male voice.

After inserting a card, the user 12 is presented with a screen 100b (FIG. 4B) inviting him to enter his PIN.

The ATM application program 72 then presents the user 12 with a screen 100c (FIG. 4C) listing transaction options available, and plays the sentence “You don't have to withdraw cash” in the same male voice as before.

After the user 12 has selected the withdraw cash option, the ATM application 72 presents the user with a screen 100d (FIG. 4D) indicating cash amounts available, and plays the sentence “Surely ten pounds is more than enough” in the same male voice.

Once the user has selected a cash amount, the ATM application 72 authorizes the transaction, presents a screen 100e (FIG. 4E) inviting the user to remove his card, and plays the sentence “Take your card” in the same male voice.

Once the user has removed his card, the ATM application 72 presents a screen 100f (FIG. 4F) inviting the user to remove the requested cash and plays the sentence “Take your money” in the same male voice.

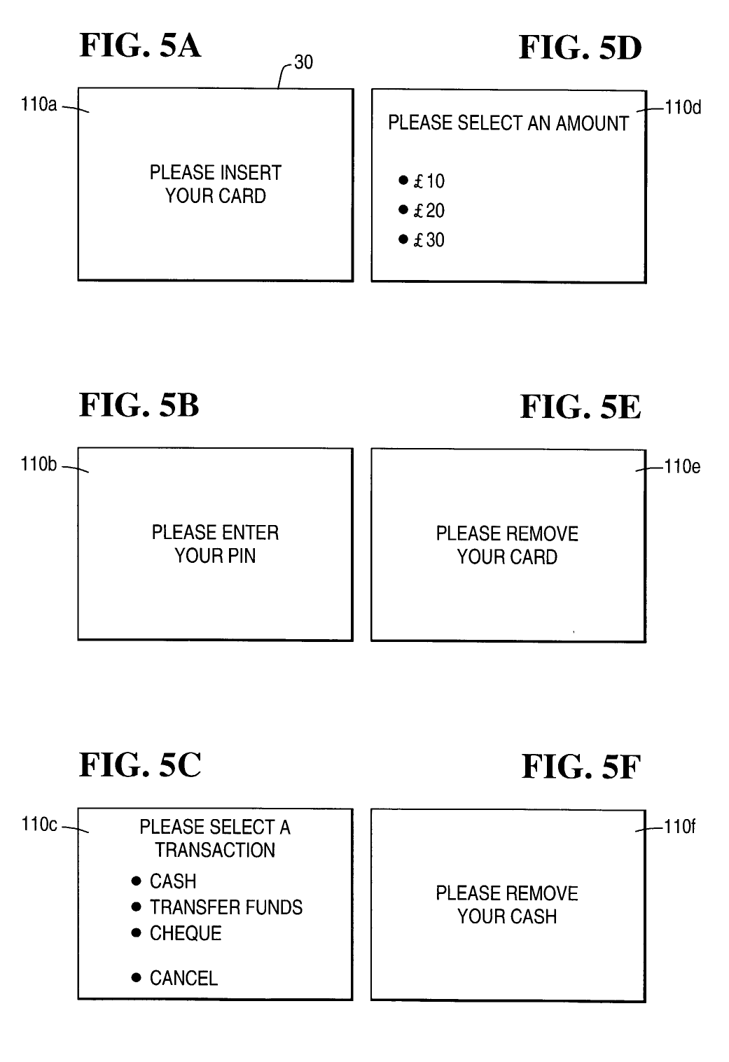

An example of a typical transaction at the ATM 10 will now be described with reference to FIGS. 5A to 5F, which illustrate the sequence of screens presented to the user 12 when the ATM is emulating another personality type. In this example, which occurs on a Saturday, the ATM 10 emulates the personality of a cheerful individual.

When the user 12 approaches the ATM 10 he is presented with a welcoming attract screen 110a (FIG. 5A) on display 30 inviting the user to insert a card. While the attract screen 110a is being displayed, the ATM application program 72 quietly plays a song through loudspeaker 16 to give passers by the impression that the ATM is happy.

After inserting a card, the ATM application program 72 presents the user 12 with a screen 110b (FIG. 5B) inviting him to enter his PIN, and plays the pre-recorded sentence “Welcome to your convenient source of cash” in a cheerful female voice.

Once the user 12 has entered a PIN, the ATM application program 72 presents a screen 110c (FIG. 5C) listing transaction options available, and plays the sentence “Please choose a transaction” in the same female voice as before.

After the user 12 has selected the withdraw cash option, the ATM application 72 presents the user with a screen 110d (FIG. 5D) indicating what cash amounts are available, and plays the sentence “How much cash would you like” in the same cheerful female voice.

Once the user has selected a cash amount, the ATM application 72 authorizes the transaction, presents a screen 110e (FIG. 5E) inviting the user to remove his card, and plays the sentence “Please remove your card” in the same female voice.

Once the user has removed his card, the ATM application 72 presents a screen 110f (FIG. 5F) inviting the user to remove the requested cash and plays the sentence “Please take your money, and enjoy your day” in the same female voice.

It will now be appreciated that the above embodiment has the advantage that an ATM can be programmed to emulate a type of personality, and that this personality type can be scheduled to change periodically. This has the advantage that a user may be surprised by the way in which such an ATM interacts with the user, thereby making cash withdrawal transactions more interesting for the user.

Various modifications may be made to the above described embodiment within the scope of the invention, for example, other personality types than those described may be provided, and other ways of emulating the personality types described may be used.

The personality settings may include a random selection so that it is even more difficult to predict how the ATM will interact with a user. The ATM may play sounds that are unrelated to a transaction, for example, songs, whistling sounds, moans, humorous stories, and such like.

In other embodiments, the self-service terminal may be a non-cash kiosk, or a point of sale terminal. The ATM may be programmed by selecting a personality composition from different personality types, so that the ATM application program 72 determines the ATM's interaction style based on the personality composition. For example, a personality composition may comprise 60% happy, 5% rude, 15% mean, 10% party, and 10% polite. The ATM may include a large number of pre-recorded sounds and sentences for playing when the ATM is not being used for a transaction, where the sounds and sentences played are consistent with the personality type or composition being emulated. The ATM may include a light sensor for adjusting the personality setting to be more happy/cheerful when the light sensor detects a large amount of light, for example, on a sunny day.

In other embodiments, the personality controller may be coded as part of the ATM application.

What is claimed is:

1. A self-service terminal comprising:
a user interface for interacting with a user;
a programmable personality controller having a plurality of personality settings; and
control means responsive to the programmable personality controller for adapting the terminal's interaction with a user in response to the setting of the personality controller.

2. A terminal according to claim 1, wherein the personality controller includes a software module having a programming interface for allowing a retailer to select one of the plurality of personality settings.

3. A terminal according to claim 1, wherein the control means includes a plurality of different pre-recorded sentences, each sentence being spoken by a plurality of different types of voices, so that each personality setting has an appropriate statement for each stage in a transaction.

4. A terminal according to claim 2, wherein the control means includes a random personality selection so that the terminal may emulate a different personality setting than the setting that was programmed by the retailer.

5. A terminal according to claim 1, wherein the personality controller includes means for storing a timetable of personality settings, so that the settings change automatically according to the time of day and/or the day of the week.

6. A terminal according to claim 1, wherein (i) same screens are used regardless of the personality type being emulated, and (ii) a personality type is emulated by playing different messages through a loudspeaker, depending on the personality type being emulated.

7. A terminal according to claim 1, wherein a screen is populated with text that is specific to a personality type.

8. An automated teller machine (ATM) comprising:
an ATM customer interface for interacting with an ATM customer;
a personality controller having a plurality of personality settings; and
means for modifying interaction of the ATM customer interface with an ATM customer based upon a selected one of the personality settings of the personality controller.

9. An ATM according to claim 8, wherein the personality controller includes a software module having a programming interface for allowing a retailer to select one of the plurality of personality settings.

10. An ATM according to claim 8, wherein the means for modifying interaction of the ATM customer interface includes a plurality of different pre-recorded sentences, each sentence being spoken by a plurality of different types of voices, so that each personality setting has an appropriate statement for each stage in an ATM transaction.

11. An ATM according to claim 9, wherein the means for modifying interaction of the ATM customer interface includes means for randomly selecting a personality setting which is different from the personality setting that was selected by the retailer.

12. An ATM according to claim 8, wherein the personality controller includes means for storing a timetable of personality settings, so that the personality settings change automatically according to the time of day and/or the day of the week.

13. An ATM according to claim 8, wherein (i) same screens are used regardless of personality type being emulated, and (ii) different messages are played through a loudspeaker to emulate a personality type, depending upon the personality type being emulated.

14. An ATM according to claim 8, wherein a screen is populated with text that is specific to a personality type.

15. A method of interacting with a user at a self-service terminal, the method comprising the steps of:
receiving a personality type to be emulated; and
providing user instructions in a manner consistent with the personality type being emulated.

16. A method of operating an automated teller machine (ATM), the method comprising the steps of:
receiving a personality type to be emulated to by the ATM; and
providing instructions to an ATM customer based upon the personality type being emulated.
